(19) United States
(12) Patent Application Publication
(10) Pub. No.: US 2020/0338809 A1
(43) Pub. Date: Oct. 29, 2020

(54) METHOD FOR MANUFACTURING A DIAL COMPRISING AT LEAST ONE THREE-DIMENSIONAL ELEMENT

(71) Applicant: ETA SA Manufacture Horlogere Suisse, Grenchen (CH)

(72) Inventors: Brice RAILLARD, Bienne (CH); Christophe EMMENEGGER, Ecuvillens (CH); Frederic JEANRENAUD, La Chaux-de-Fonds (CH)

(73) Assignee: ETA SA Manufacture Horlogere Suisse, Grenchen (CH)

(21) Appl. No.: 16/771,310

(22) PCT Filed: Nov. 30, 2018
(86) PCT No.: PCT/EP2018/083083

§ 371 Date: Jun. 10, 2020

(30) Foreign Application Priority Data
Dec. 20, 2017 (EP) 17209108.4

(51) Int. Cl. B29C 64/112; G04B 19/12; G04B 19/10; B33Y 50/02; B33Y 80/00; B29C 64/393

(52) U.S. Cl. CPC B29C 64/112; G04B 19/12; B29C 64/393; B33Y 50/02; B33Y 80/00; G04B 19/10

(57) ABSTRACT

The invention relates to a method for manufacturing a dial (11) comprising at least one three-dimensional element (30), the method comprising the following steps of:
generating (44), by means of a control unit (2), at least one control command for a printing device (3) for reproducing a reference digital graphical representation (9a) relating to said dial (11) provided with at least one three-dimensional element (30), and
constructing (45), by means of the printing device (3), at least two superimposed layers comprising printed particles on a support element forming said dial (11), and
removing (52) the dial (11) from said support element.

### TECHNICAL FIELD

The present invention relates to a method for manufacturing a dial comprising at least one three-dimensional element and a system implementing such a method.

The invention further relates to such a dial in addition to a timepiece provided with this dial. The invention further relates to a computer program.

### PRIOR ART

In the prior art, timepiece dials are generally planar, the sole three-dimensional elements whereof are appliques such as the numbers of the hours as well as indexes disposed at regular intervals around the periphery of these dials in order to ease the reading of the time relative to the angular position of the hands. The production of appliques and indexes remains a complex procedure and the placement thereof on a dial is a tedious operation.

Nonetheless, various methods exist for manufacturing dials having three-dimensional elements with the advantage of overcoming the aforementioned drawbacks.

By way of example, European patent No. 2452231 discloses a method for manufacturing a dial provided with three-dimensional elements that are at least partially coated in a decorative layer. The method consists of forming the dial, then of selectively modifying the surface state of the dial in order to locally change the adherence thereof relative to the decorative layer. The decorative layer is then directly deposited on the entire dial, and finally, the parts of the deposited layer that are not adhered to the dial are removed.

European patent No. 2370865 also discloses a method for manufacturing a dial provided with three-dimensional elements consisting of producing a mask on a dial of a timepiece, the thickness whereof corresponding to the desired thickness of the three-dimensional elements intended to decorate this dial, and having at least one opening. This mask is then placed against the dial with the opening disposed at the location of the part of the dial to be decorated so as to fill, by hot working, the opening of the mask with a material that is at least partially amorphous. Finally, the mask is removed in order to obtain the three-dimensional element on the dial of this timepiece.

However, these two methods are relatively complex to perform as a result of the high number of operations required for the implementation thereof and the different types of tooling required.

Moreover, it should be noted that the conventional method for manufacturing a dial blank, onto which three-dimensional elements are applied, generally involves a plurality of operations. A dial plate, for example made of aluminium or brass, is firstly stamped in order to cut the outer contour, the central hole and, depending on the type of movement, the one or more apertures of the dial blank. A smoothing operation is then carried out using abrasive paper in order to remove the machining residues, followed by a surface pumicing operation, then a polishing operation using brushes equipped with cotton discs in order to obtain a perfectly smooth surface.

Following the example of the manufacturing methods as described in European patent No. 2370865 and 2452231, the production of a dial blank according to the conventional manufacturing method has the drawback of requiring different types of tooling and know-how which requires qualified manpower with clear repercussions on production costs.

### SUMMARY OF THE INVENTION

One purpose of the present invention is thus to propose a method for manufacturing a dial comprising at least one three-dimensional element such as a decorative element or a raised pattern defined on a surface of this dial in a fast and simple manner and which further contributes to improving the large-scale, automated, and cost-effective production of such dials.

In this respect, the invention relates to a method for manufacturing a dial comprising at least one three-dimensional element, the method comprising the following steps of:
generating, by means of a control unit, at least one control command for a printing device for reproducing a reference digital graphical representation relating to said dial provided with at least one three-dimensional element, and
constructing, by means of a particle jet from the printing device, at least two superimposed layers comprising printed particles on a support element forming said dial, and
removing the dial from said support element.

Thus, by virtue of these features, the manufacturing method allows a dial to be produced comprising at least one three-dimensional element by way of a reduced number of operations which are easy and fast to implement.

In other embodiments:
the construction step comprises a sub-step of producing a dial blank including the phase of applying at least one layer of particles on the support element and the phase of treating said at least one layer of printed particles;
the application of at least one layer of particles is carried out continuously on the support element so as to obtain a solid dial blank;
the application of printed particles is carried out discontinuously on the support element so as to obtain a skeleton-type dial blank;
the construction step comprises a sub-step of producing at least one three-dimensional element including the phase of selectively applying at least one layer of at least one particle on said dial blank so and the phase of treating said at least one layer of at least one particle;
the application of at least one layer of at least one particle is carried out discontinuously on said dial blank;
the application phases provide for having the control unit execute said at least one control command comprising data describing layers constituting said reference digital graphical representation to be reproduced;
the application phases provide for depositing at least one ink comprising said at least one particle;
said ink comprises a fluid carrying said at least one particle or particles, the fluid being chosen from among a solvent, a viscoelastic polymer, an oil, water and/or an aqueous solution;
the treatment phases comprise a sub-phase of fixing said layer onto the dial blank or onto the support element;
the fixing phase provides for exposing the layer to an airflow, in particular a hot airflow and/or to light radiation, in particular ultraviolet radiation or infrared radiation; and
the particle is comprised in an ink such as a coloured ink comprising pigmented or coloured particles, or a colourless or transparent or translucent ink comprising colourless or transparent or translucent particles, or a functional ink comprising functional particles.

The invention further relates to a dial comprising at least one three-dimensional element capable of being obtained using such a method.

Advantageously, the dial forms a single piece with said at least one three-dimensional element.

The invention further relates to a timepiece having at least one such dial.

The invention further relates to a system for manufacturing a dial comprising at least one three-dimensional element implementing the method, the system comprising a printing device and a control unit, said printing device being connected to said control unit.

Advantageously, the control unit comprises hardware and software resources, said hardware resources comprising memory elements having at least one reference digital graphical representation relative to the dial to be manufactured and descriptive data relating to said at least one reference digital graphical representation.

The invention further relates to a computer program comprising program code instructions for executing the steps of the method when said program is executed by a control unit.

25

### BRIEF DESCRIPTION OF THE FIGURES

Other features and advantages of the present invention will appear after reading the plurality of embodiments, which are provided for purposes of illustration only and not intended to limit the scope of the invention, given with reference to the accompanying drawings, wherein:

FIG. 1 is a diagrammatic view of a system for manufacturing a dial comprising at least one three-dimensional element, according to one embodiment of the invention;

FIG. 2 is a flow chart relating to a method for manufacturing a dial comprising at least one three-dimensional element, according to the embodiment of the invention;

FIG. 3 is a diagrammatic view of a timepiece comprising at least one dial, according to the embodiment of the invention;

FIG. 4 shows a diagrammatic view of a printing device of the system capable of contributing to the construction of a solid dial blank, according to the embodiment of the invention;

FIG. 5A shows a diagrammatic view of the printing device of the system capable of contributing to the construction of a skeleton-type dial blank, according to the embodiment of the invention;

FIG. 5B shows an overhead view of the skeleton-type dial blank, according to the embodiment of the invention;

FIG. 5C shows a sectional view of FIG. 5B along the axis A-A, according to the embodiment of the invention; and

FIGS. 6, 7, 8 and 9 each show a view of an example dial obtained, according to the embodiment of the invention.

### DETAILED DESCRIPTION OF THE INVENTION

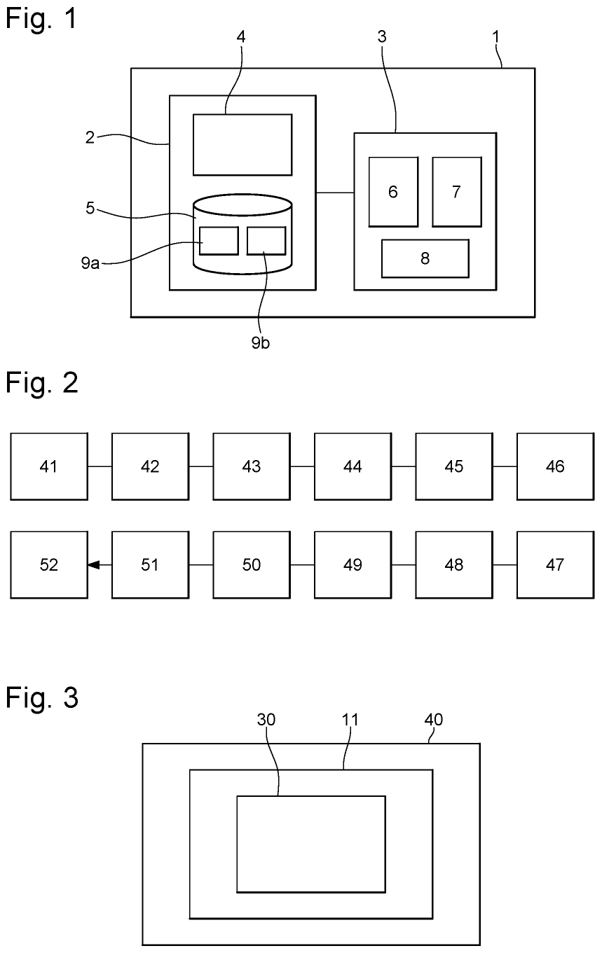

With reference to FIGS. 1 and 3, the system for manufacturing a dial 11 of a timepiece 40 comprising at least one three-dimensional element 30, includes a control unit 2 and a printing device 3. The dial 11 can, for example, be a solid dial or a skeleton-type dial. The dial, in addition to the three-dimensional element 30 comprised therein, can be coloured, multicoloured, monochromatic, transparent or translucent. The three-dimensional element 30 can comprise an Arabic or Roman numeral, an index or even an applique arranged on the periphery of the dial. It should be noted that the dial comprising at least one three-dimensional element is formed from a plurality of layers applied to a support element, the layers being superimposed and each comprising at least one particle which is thus, in this case, printed on said support element. This particle, otherwise referred to as a “usable particle” or a “characterising particle” is that which characterises the corresponding layer as regards at least one of the features of this layer, for example the nature thereof, the texture thereof, the character thereof, the colour thereof, the shade thereof, and/or the function thereof, etc. It is thus understood that this is a specific particle of the layer, said layer capable of being formed by a plurality of other types of particle different from “this usable particle”.

In this system 1, the control unit 2 is connected to the printing device 3 in particular to ensure control of this device 3. The control unit 2 can be a computer or even a microcontroller by comprising hardware and software resources, in particular at least one processor 4 cooperating with memory elements 5. This control unit 2 is capable of executing commands to implement a computer program.

In this control unit 2, the memory elements 5 comprise, in addition to the computer program, data relating to at least one reference digital graphical representation 9a to be reproduced relative to the dial 11, in addition to descriptive data 9b relating to said at least one reference digital graphical representation 9a. A reference digital graphical representation 9a comprises, for example, a reference three-dimensional 3D graphical representation or a reference two-dimensional 2D graphical representation. It should be noted that the reference digital graphical representation 9a is generated by a design module of the system 1 which is connected to the control unit 2 capable of comprising a two-dimensional/three-dimensional digital imaging device or even by a software tool executed by the control unit 2 allowing for virtual 2D/3D modelling from photographs or images, or even allowing a virtual three-dimensional digital object to be designed (for example a computer-aided design software more commonly known as CAD software).

Such a printing device 3 shown in FIGS. 1, 4 and 5A comprises a printing member 6, a fixing member 7 and a drive member 8. The printing member 6 comprises a plurality of printing entities, in particular inkjet cartridges, each cartridge comprising a printhead 12a to 12d in the present embodiment, each cartridge comprises a printhead 12a to 12d and at least one inkjet reservoir. In these cartridges, the ink has at least one particle that can be comprised in a fluid. Such a fluid is provided to ensure the carriage of said at least one particle on the support on which it must be deposited, in this case a support element and the dial formed, during the ejection thereof from the cartridge. Such a fluid can be any body capable of ensuring this carriage. This fluid can be chosen, in a non-limiting and non-exhaustive manner, from a solvent, a viscoelastic polymer, an oil, water and an aqueous solution. For the purposes of illustration, when this is a viscoelastic polymer, this fluid is a viscoelastic polymer fluid in the liquid phase which is non-polymerised and which is preferably capable of photopolymerisation. It should be noted that, in an alternative embodiment, said at least one particle can be deposited on this support without requiring such a fluid for ensuring the carriage thereof. The cartridges of this printing member 6 can comprise inks such as:
a coloured ink having pigmented or coloured particles, or
a colourless or transparent or translucent ink, such as a lacquer, having colourless or transparent or translucent particles, or
a functional ink having functional particles and which is selected from the group formed of an electroluminescent ink, a phosphorescent ink, photoluminescent ink, a conductive ink, a semi-conductive ink, an electroactive ink, a magnetic ink, a photochromic ink, an electrochromic ink, a thermochromic ink, an ionochromic ink and a mechanochromic ink.

In this context, a layer formed by at least one functional particle and/or by at least one coloured or pigmented particle, and/or by at least one colourless or transparent or translucent particle, can have, in a non-exhaustive and non-limiting manner:
a white colour only;
a white colour having a matt or gloss finish due to the presence of at least one colourless or transparent or translucent particle;
a black colour only;
a black colour having a matt or gloss finish due to the presence of at least one colourless or transparent or translucent particle;

a wide variety of colours owing to the four-colour printing technique which implements primary colours such as cyan, magenta, yellow and black (referred to as the CMYK system), allowing this wide variety of colours to be reproduced from three elementary colours, a blue-green referred to as cyan, a red referred to as magenta and a yellow, to which colours the colour black is added.

In addition, such a printing device 3 is furthermore capable of contributing to the manufacture of such a dial 11 at a low resolution or even at a high resolution that can be greater than or equal to 2,400 dpi (pixels per inch).

In this printing device 3, the drive member 8 is capable of causing the printing member 6 to move in various directions relative to a support element of the system 1 on which the dial 11 can be manufactured. This support element, which is capable of passing in front of the printheads 12a to 12d can, for example, take on the shape of a non-adhesive and lubricated sheet in order to be able to easily detach the dial 11 once the manufacture thereof is complete. The fixing member 7 is provided to ensure the fixing of a layer of at least one particle or particles to the support element or to a first layer or an initial layer already present on this timepiece component 10. This fixing member 7 comprises a module that is capable of emitting ultraviolet UV radiation and/or infrared radiation and/or an airflow, in particular a hot airflow. This module is capable of generating radiation or an airflow over all or part of an assembly area of the support element on which the dial 11 can be built. It should be noted that when the different inks mentioned above comprise a viscoelastic polymer fluid, the module is a photopolymerisation module provided with an ultraviolet UV radiation source and which is therefore capable of generating UV radiation over all or part of the assembly area of the surface of the support element on which the dial 11 can be built.

Such a system 1 is capable of implementing a method for manufacturing a dial 11 comprising at least one three-dimensional element 30 shown in FIG. 2.

This method comprises a step 41 of generating at least one reference digital graphical representation 9a. During this step 41, this reference digital graphical representation 9a can be produced from a three-dimensional digital imaging, or when the control unit 2 executes a 2D/3D virtual modelling software or software for designing a three-dimensional virtual digital object (for example a computer-aided design software, more commonly referred to under the acronym CAD). Once generated, this reference digital graphical representation 9a is archived in the format of a digital data file in the memory elements 5 of the control unit 2. In other words, such a file comprises information data relating to the reference digital graphical representation 9a.

The method then provides for a step 42 of determining descriptive data 9b relating to said reference digital graphical representation 9a. Such a step 42 is implemented by the control unit 2 and thus allows descriptive data 9b to be determined, which data contributes in particular to selecting the one or more types of ink required to produce the dial 11 on the assembly area of the support element as well as the direction of movement of the printing member 6 relative to the assembly area. During this step 42, this file and in particular the information data relating to the reference digital graphical representation 9a are processed, in particular by implementing a process for digitally dividing/cutting this graphical representation 9a into at least two layers in a:
transverse direction that can be horizontal, vertical or oblique;
longitudinal direction that can be horizontal, vertical or oblique.

More specifically, during this processing, the control unit 2 determines elements that are characteristic of each layer obtained, such as:
at least one dimension of each layer, which can be, for example, for each layer, a thickness, length, width, surface area, or volume, etc.;
visual/aesthetic/structural aspects, i.e. visual and/or aesthetic and/or structural aspects of the reference digital graphical representation 9a such as colour and/or texture, etc.;
physical and/or chemical functional characteristics that the dial 11 provided with at least one three-dimensional element 30 must have and which are, for example, related to:
   electrical conductivity, semiconductive or insulating nature;
   semiconductivity;
   electroluminescence;
   photoluminescence (for example a reaction to ultraviolet radiation);
   phosphorescence;
   “X-chromism” (photochromic, electrochromic, thermochromic, ionochromic, mechanochromic, etc.);
   electroactivation;
   magnetism;
   etc.

These characteristic elements of each layer constitute the descriptive data 9b relating to the reference digital graphical representation 9a that are archived in the memory elements 5 of the control unit 2.

The method for manufacturing this dial 11 further comprises a step 43 of selecting the reference digital graphical representation 9a that must be reproduced on the assembly area of the support element in order to form the dial 11 having at least one three-dimensional element 30. During this selection step 43, this reference digital graphical representation 9a can thus be selected using a man-machine interface (MMI) connected to the control unit 2.

The method then provides for a step 44 of generating, by means of the control unit 2, at least one control command for controlling the printing device 3, said at least one command being intended to reproduce the reference digital graphical representation 9a. This step 44 of generating said at least one control command is carried out on the basis of the descriptive data 9b relating to the layers forming the reference digital graphical representation 9a to be reproduced. Said at least one command comprises criteria for controlling the printing device 3 and in particular the printing member 6 and the fixing member 7. These criteria in particular comprise data relating to:
a selection of cartridges comprising the printheads 12a to 12d required for reproducing each layer of the reference digital graphical representation 9a and, depending on the ink that they contain, in particular for reproducing the visual/aesthetic/structural aspects and/or the functional characteristics of each of these layers;
a movement of the printhead 12a to 12d of each cartridge relative to the assembly area of the support element for reproducing at least one dimension and/or the visual/aesthetic/structural aspects and/or the functional characteristics of each layer of the reference digital graphical representation 9a;
a distance and/or positioning of the printhead 12a to 12d of each cartridge relative to the assembly area of the support element for reproducing at least one dimension and/or the visual/aesthetic/structural aspects and/or the functional characteristics of each layer of the reference digital graphical representation 9;
a duration of the positioning of the printhead 12a to 12d of each cartridge relative to the assembly area of the support element for reproducing at least one dimension and/or the visual/aesthetic/structural aspects and/or the functional characteristics of each layer of the reference digital graphical representation 9a;
an ink flow ejected from the printheads 12a to 12d, in particular the number of droplets ejected for reproducing at least one dimension and/or the visual/aesthetic/structural aspects and/or the functional characteristics of each layer of the reference digital graphical representation 9a.

The method then comprises a step 45 of constructing, by a jet of at least particles from the printing device 3, at least two superimposed layers jointly comprising printed particles on the support element, said layers forming the dial 11 provided with at least one three-dimensional element 30. During this step 45, the particles are sprayed onto the support element. These particles can be included in the same nozzle or in a plurality of different nozzles of the printhead. It should thus be noted that, as stated hereinabove, the particle can be deposited on the support by being included in a fluid or in an alternative embodiment without the need for such a fluid to ensure the carriage thereof.

Each printed particle is included in one of the aforementioned functional, coloured and/or colourless/transparent/translucent inks. More specifically, it should be noted that a layer can be formed solely from at least one printed particle type or from a plurality of different particle types, i.e. functional, coloured and/or colourless/transparent/translucent printed particles.

This construction step 45 comprises a sub-step 46 of producing a dial blank 10, 20. This dial blank 10, 20 includes a generally planar surface thus devoid of raised portions. This sub-step 46 comprises a phase 47 of applying at least one layer of particles to the assembly area of the support element. This application of the layer can be carried out continuously or discontinuously. As mentioned above, each particle can be a functional, coloured and/or colourless/transparent/translucent particle. It is understood that this layer can comprise a plurality of particle types that may or may not be different, selected from functional, coloured or colourless/translucent/transparent particles. Moreover, this application sub-step provides for having the control unit 2 execute said at least one control command comprising data describing said reference digital graphical representation 9a to be reproduced. The execution of said at least one command enables, within the scope of the application of this layer, control over the deposition of at least one ink comprising the particles and optionally other inks comprising other functional, coloured or colourless/translucent/transparent particles. The production sub-step 46 then comprises a phase 48 of treating said at least one layer of particles directly following the application phase 47. This phase 48 of treating said layer of particles comprises a sub-phase of fixing said layer of particles onto the support element. This fixing sub-phase provides for exposing the layer of particles to an airflow, in particular a hot airflow and/or to light radiation, in particular to ultraviolet (UV) radiation or infrared radiation. The purpose of this fixing sub-phase is thus to transform the layer of particles that is in a paste or liquid state into a layer of at least one printed particle that is in a solid, rigid, resilient, dry, cured and/or infusible state. Thus, this transformation results in obtaining a layer of printed particles on the support element. It should be noted that such a transformation has the advantage of being carried out very quickly, generally in less than one second.

More specifically during this production sub-step 46, and in particular during the execution of the application phase 47, the control unit 2 executes said at least one control command comprising data 9b describing a layer constituting said reference digital graphical representation 9a to be reproduced. The printing device 3 subsequently applies a first layer of particles, otherwise referred to as the initial layer, directly onto the assembly area of the support element provided for this purpose according to said at least one executed control command.

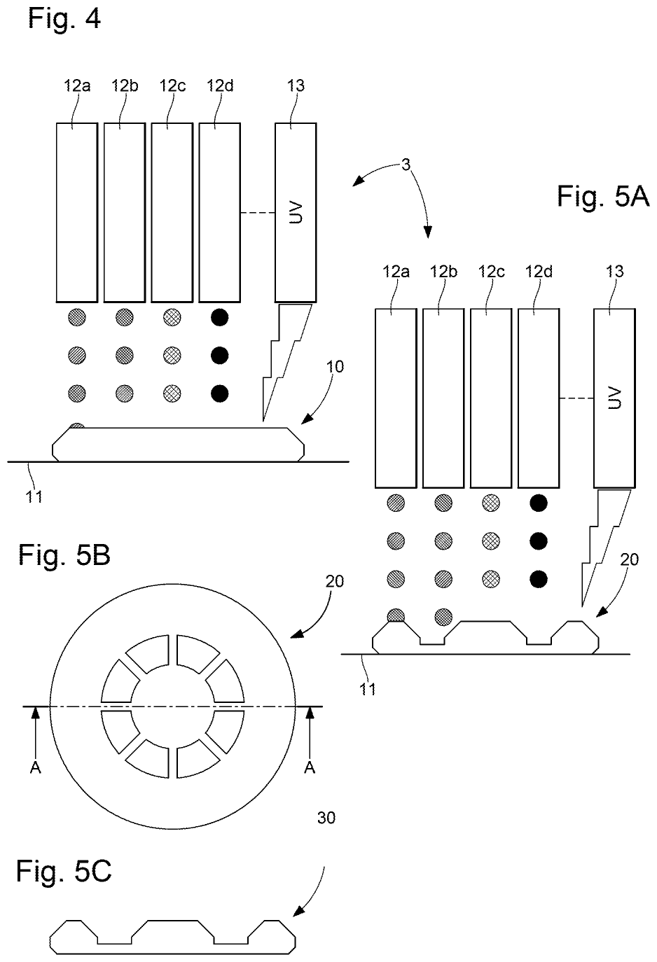

With reference to FIGS. 2 and 4, in a first alternative embodiment of this production sub-step 46 intended to obtain a solid dial blank 10, the deposition/application on the assembly area of the layer of particles is carried out continuously. In other words, in this alternative embodiment, the first layer is thus applied continuously onto the assembly area during a first passage of the printheads 12a, 12b, 12c, 12d above the support element thus producing a first portion of the height of the dial blank 10. This first layer of particles is then subjected to the fixing sub-phase of the treatment phase 48 during which this first layer is exposed to an airflow, in particular a hot airflow and/or to light radiation, in particular to ultraviolet (UV) radiation or infrared radiation. According to said at least one executed control command, a second layer of particles can be applied continuously onto the first layer of printed particles on the support element during a second passage of the printheads 12a to 12d above the assembly area in order to produce a second portion of the height of the dial blank 10. This second layer of particles is also subjected to the fixing sub-phase of the treatment phase 48 in order to transform this second layer into a second layer of printed particles on the first layer of printed particles on the support element.

In this first alternative embodiment, the application and treatment phases 47, 48 can be repeated a third time in order to obtain a dial blank 10 having a thickness of about 0.5 mm so as to ensure good mechanical stability of the dial 11. This operation can also be renewed a fourth, a fifth or even a sixth time as a function of the desired thickness of the dial blank. As a whole, the thickness of the solid dial blank 10 obtained by the manufacturing method according to the invention can vary between 0.3 mm and 1 mm or more. As a result, the number of layers of printed particles can vary as a function of the thickness of the dial blank 10. A minimum number of two superimposed layers of printed particles is desired so as to obtain good mechanical strength of the dial 11, although a single layer of printed particles procuring a satisfactory mechanical strength cannot be ruled out depending on the properties of the inks used.

With reference to FIGS. 2 and 5A, in a second alternative embodiment of this production sub-step 46 intended to obtain a skeleton-type dial blank 20 (visible in FIGS. 5B and C), the deposition/application on the assembly area of the layer of particles is carried out discontinuously. In other words, in this alternative embodiment, the first layer is thus applied discontinuously onto the assembly area during a first passage of the printheads 12a, 12b, 12c, 12d above the support element thus producing a first portion of the height of the dial blank 20. This first layer of particles is then subjected to the fixing sub-phase of the treatment phase 48 during which this first layer is exposed to an airflow, in particular a hot airflow and/or to light radiation, in particular to ultraviolet (UV) radiation or infrared radiation. According to said at least one executed control command, a second layer of particles can be applied discontinuously onto the first layer of printed particles on the support element during a second passage of the printheads 12a to 12d above the assembly area in order to produce a second portion of the height of the dial blank 20. This second layer of particles is also subjected to the fixing sub-phase of the treatment phase 48 in order to transform this second layer into a second layer of printed particles on the first layer of printed particles on the support element.

In this second alternative embodiment, the application and treatment phases 47, 48 can be repeated a third time in order to obtain a dial blank 20 having a thickness of about 0.5 mm so as to ensure good mechanical stability of the dial 11. This operation can also be renewed a fourth, a fifth or even a sixth time as a function of the desired thickness of the dial blank 20. As a whole, the thickness of the skeleton-type dial blank 20 obtained by the manufacturing method according to the invention can vary between 0.3 mm and 1 mm or more. As a result, the number of layers of printed particles can vary as a function of the thickness of the dial blank 20. A minimum number of two superimposed layers of printed particles is desired so as to obtain good mechanical strength of the dial 11, although a single layer of printed particles procuring a satisfactory mechanical strength cannot be ruled out depending on the properties of the inks used.

The construction step then comprises a sub-step 49 of producing at least one three-dimensional element 30. This sub-step 49 comprises a phase 50 of selectively applying a layer of at least one particle onto said dial blank 10, 20. This selective application of said at least one layer allows for the creation of the three-dimensional element 30 such that it has a raised portion relative to a planar surface of the dial blank 10, 20. In other words, this application of the layer is carried out discontinuously on this dial blank 10, 20. As mentioned above, the particle can be coloured and/or functional and/or colourless/transparent/translucent. It is understood that this layer can comprise a plurality of particle types selected from coloured, functional and/or colourless/translucent/transparent particles. It should be noted that said at least one layer deposited on the dial blank 10, 20 can have a constant thickness at all points or an uneven thickness. The production sub-step 49 then comprises a phase 51 of treating said at least one layer of at least one particle directly following the application phase 50. This treatment phase 51 comprises a sub-phase of fixing said layer of at least one particle onto the dial blank 10, 20. This fixing sub-phase provides for exposing the layer of at least one particle to an airflow, in particular a hot airflow and/or to light radiation, in particular to ultraviolet (UV) radiation or infrared radiation. The purpose of this fixing sub-phase is thus to transform the layer of at least one particle that is in a paste or liquid state into a layer of at least one printed particle that is in a solid, rigid, resilient, dry, cured and/or infusible state. Thus, this transformation results in obtaining a layer of at least one printed particle on the dial blank 10, 20. It should be noted that such a transformation has the advantage of being carried out very quickly, generally in less than one second.

More specifically during this production sub-step 49, and in particular during the execution of the application phase 50, the control unit 2 executes said at least one control command comprising data 9b describing a layer constituting said reference digital graphical representation 9a to be reproduced. The printing device 3 subsequently applies a first layer of at least one particle directly onto the dial blank 10, 20 according to said at least one executed control command. This first layer of at least one particle is then subjected to the fixing sub-phase of the treatment phase 51 during which this first layer is exposed to an airflow, in particular a hot airflow and/or to light radiation, in particular to ultraviolet (UV) radiation or infrared radiation. The printing device 3 can subsequently provide for applying a second layer of at least one particle onto the first layer of at least one printed particle that is already present on the dial blank 10, 20, according to said at least one executed control command. This second layer of at least one particle is also subjected to the fixing sub-phase of the treatment phase 51 in order to transform this second layer into a second layer of at least one printed particle on the first layer of at least one printed particle on the dial blank 10, 20.

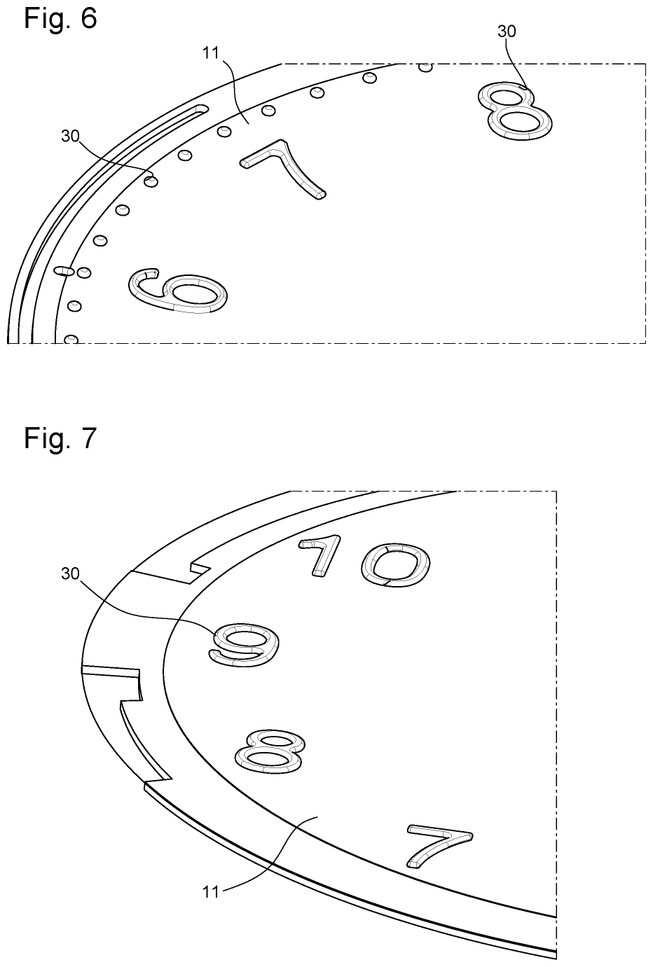

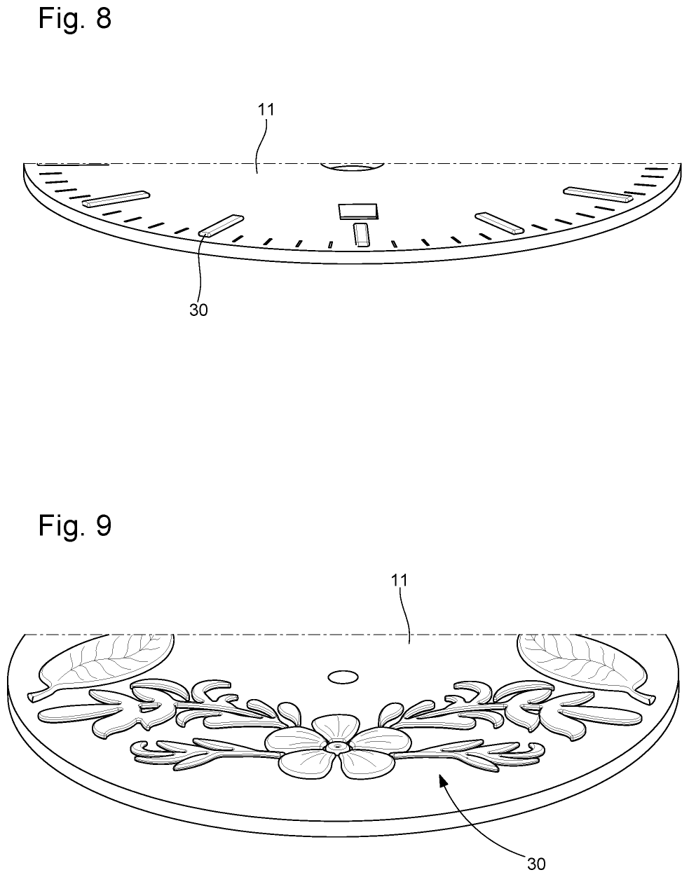

Thus, the three-dimensional elements 30 such as the Arabic numerals in FIGS. 6 and 7 or such as the indexes in FIG. 8 are produced by superimposing a plurality of layers of at least one printed particle on specific areas of the dial blank 10, 20 so as to have numerals and indexes of a thickness that exceeds 100 microns so as to be visible to the naked eye by the individual wearing a watch including the dial 11 obtained using the method according to the invention. In general, the superimposition of three layers of at least one printed particle is sufficient to procure a raised portion for the dial 11. It should be noted that, according to the properties of the inks used, a method for manufacturing a dial 11 having a three-dimensional element 30 of a thickness of at least 100 microns by the superimposition of only two layers of at least one printed particle can be implemented. FIG. 9 shows a dial 11 including a more marked three-dimensional element 30, the thickness whereof can be obtained by superimposing four or five layers of at least one printed particle.

In this context, the three-dimensional element 30 can comprise a pattern or an image that is sufficiently elevated relative to the planar surface of the dial blank 10, 20 in order to constitute a raised decoration that is visible to the naked eye of the individual wearing the timepiece 40 including the dial 11 produced according to the method of the invention. Thus, as mentioned hereinabove, the three-dimensional element 30 can in particular be the numerals of the hours (for example Arabic or Roman numerals), indexes or a drawing extending over the majority or a part of the dial blank 10, 20.

It should be noted that each layer of at least one viscoelastic polymer fluid can have a thickness that lies in the range 10 to 150 microns, and is preferably equal to 100 microns.

Moreover, it should be noted that once the three-dimensional element 30 is produced, the method can provide for a potential step of depositing a layer of at least one colourless/translucent/transparent ink on the entire dial 11 or on specific parts of the dial 11 in order to obtain a matt or gloss finish.

This method subsequently comprises a step 52 of removing the dial 11 obtained from the support element of the system 1 before being conditioned until fitting a timepiece 40.

The invention further relates to a computer program comprising program code instructions for executing the steps of this method when said program is executed by the control unit 2.

1-18. (canceled)

19. A method for manufacturing a dial comprising at least one three-dimensional element, the method comprising:
generating, by means of a control unit, at least one control command for a printing device for reproducing a reference digital graphical representation relating to the dial provided with at least one three-dimensional element,
constructing, by means of a particle jet from the printing device, at least two superimposed layers comprising printed particles on a support element forming the dial, and
removing the dial from the support element.

20. The method according to claim 19, wherein the construction step comprises a sub-step of producing a dial blank including the following phases of:
applying at least one layer of particles onto the support element; and
treating the at least one layer of printed particles.

21. The method according to claim 19, wherein the application of at least one layer of particles is carried out continuously on the support element so as to obtain a solid dial blank.

22. The method according to claim 19, wherein the application of printed particles is carried out discontinuously on the support element so as to obtain a skeleton-type dial blank.

23. The method according to claim 19, wherein the construction step comprises a sub-step of producing at least one three-dimensional element including the following phases of:
selectively applying at least one layer of at least one particle onto the dial blank; and
treating the at least one layer of at least one particle.

24. The method according to claim 19, wherein the application of at least one layer of at least one particle is carried out discontinuously on the dial blank.

25. The method according to claim 19, wherein the application phases provide for having the control unit execute the at least one control command comprising data describing layers constituting the reference digital graphical representation to be reproduced.

26. The method according to claim 19, wherein the application phases provide for depositing at least one ink comprising the at least one particle.

27. The method according to claim 19, wherein the ink comprises a fluid carrying the at least one particle or particles, the fluid being chosen from among a solvent, a viscoelastic polymer, an oil, water, and an aqueous solution.

28. The method according to claim 19, wherein the treatment phases comprise a sub-phase of fixing the layer onto the dial blank or onto the support element.

29. The method according to claim 19, wherein the fixing phase provides for exposing the layer to an airflow, in particular a hot airflow and/or to light radiation, in particular ultraviolet (UV) radiation or infrared radiation.

30. The method according to claim 19, wherein the particle is included in an ink including one of:
a colored ink comprising pigmented or colored particles,
a colorless or transparent or translucent ink comprising colorless or transparent or translucent particles, and
a functional ink comprising functional particles.

31. A dial comprising at least one three-dimensional element obtained by the method according to claim 19.

32. The dial according to claim 29, wherein the dial forms a single piece with the at least one three-dimensional element.

33. A timepiece comprising at least one dial according to claim 31.

34. A system for manufacturing a dial comprising at least one three-dimensional element implementing the method according to claim 19, the system comprising a printing device and a control unit, the printing device being connected to the control unit.

35. The system according to claim 34, wherein the control unit comprises hardware and software resources, the hardware resources comprising memory elements having at least one reference digital graphical representation relative to the dial to be manufactured and descriptive data relating to the at least one reference digital graphical representation.

36. A non-transitory computer-readable medium storing a program for executing the steps of the method according to claim 19, when the program is executed by a computer.
